(19) United States
(12) Patent Application Publication
(10) Pub. No.: US 2004/0246741 A1
(43) Pub. Date: Dec. 9, 2004

(54) Vehicle light with light emitting diode (LED) light source

(75) Inventors: Chenhua You, Manasquan, NJ (US); Mohamed Abdelhafez, Old Bridge, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: DIALIGHT CORPORATION, FARMINGDALE, NJ

(21) Appl. No.: 10/455,393

(22) Filed: Jun. 6, 2003

(51) Int. Cl. B60Q 1/26

(52) U.S. Cl. 362/541; 362/544; 362/240

(57) ABSTRACT

An LED light, such as used as a vehicle backup light, includes an LED board having first and second sides. At least one LED is mounted on the first side. A lens is positioned at a distance from the LED board to face the first side of the LED board. A potting compound is provided on the second side of the LED board. The potting compound can completely fill the second side of the LED board. The lens can include a first surface facing an external side of the LED light that is substantially smooth, to prevent collecting dust therein, and a second surface facing the LED board. That second surface can be contoured to include an upper region to refract light in a first direction, a lower region to reflect light in a second direction opposite to the first direction, and a middle region including horizontal grooves. That middle region may diverge light in a horizontal direction and converge light in a vertical direction.

### BACKGROUND OF THE INVENTION

1. Field of the Invention

The present invention is directed to a vehicle light to be utilized in vehicle lighting systems, for example as a backup light in an automobile lighting system. The light of the present invention utilizes light emitting diodes (LEDs) as its light source.

2. Background of the Invention

Vehicles, such as automobiles, include many types of lights, such as backup lights that provide a visual indication when a vehicle is placed in reverse. Conventionally such lights utilize incandescent light bulbs as their light source. The drawback with utilizing an incandescent lamp as the light source is that an incandescent lamp has a relatively short life and must be frequently replaced, and is also relatively energy inefficient.

It has been known to utilize white LEDs in backup lights and license plate illuminators in vehicle lighting contexts. For example, a background backup light from Truck-Lite utilizes an LED as its light source and mounts LEDs on an LED board inside a housing and includes a lens with lens details on both sides of the lens. However, that device has a drawback in that as the lens has lens details on both sides, the lens collects dust easily, which thereby reduces signal intensity.

### SUMMARY OF THE INVENTION

Accordingly, one object of the present invention is to provide a novel (LED) light emitting diode light for a vehicle lighting. Such a light may find particular application as a vehicle backup light.

A further object of the present invention is to provide a novel LED light for a vehicle lighting that is energy efficient, has a long life, and has an efficient lens system.

A further object of the present invention is to provide a novel LED light for a vehicle lighting that has improved heat sinking properties, to further lengthen the life of the LED light and to improve operating efficiency.

To achieve the above and other objects the novel LED light of the present invention includes an LED board having first and second sides. At least one LED is mounted on the first side. A lens is positioned at a distance from the LED board to face the first side of the LED board. A potting compound is provided on the second side of the LED board.

Further, the potting compound can completely fill the second side of the LED board, and the potting compound can include a silicon based resin and a hardener material.

Further, the lens can include a first face facing an external side of the LED vehicle backup light that is substantially smooth, to prevent collecting dust therein, and a second face facing the LED board. That second face can be contoured to include an upper region to refract light in a first direction, a lower region to refract light in a second direction opposite to the first direction, and a middle region. The middle region may diverge light in a horizontal direction and converge light in a vertical direction.

Further, the lens can include a shelf configured to maintain the LED board at a predetermined distance from the lens.

Further, the LED board can include a plurality of rows of LEDs, and the lens can include a plurality of rows of horizontal bands in the middle region with one of the rows of horizontal bands aligning with one respective row of LEDs.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 shows the LED light of the present invention in a completed view;

FIG. 2 shows the LED light of the present invention in an expanded view;

FIGS. 3A-3E detail the lens structure of the LED light of the present invention; and

FIGS. 4A and 4B show a diagram of light rays output by the LEDs and passing through the lens in the LED light of the present invention.

### DESCRIPTION OF THE PREFERRED EMBODIMENTS

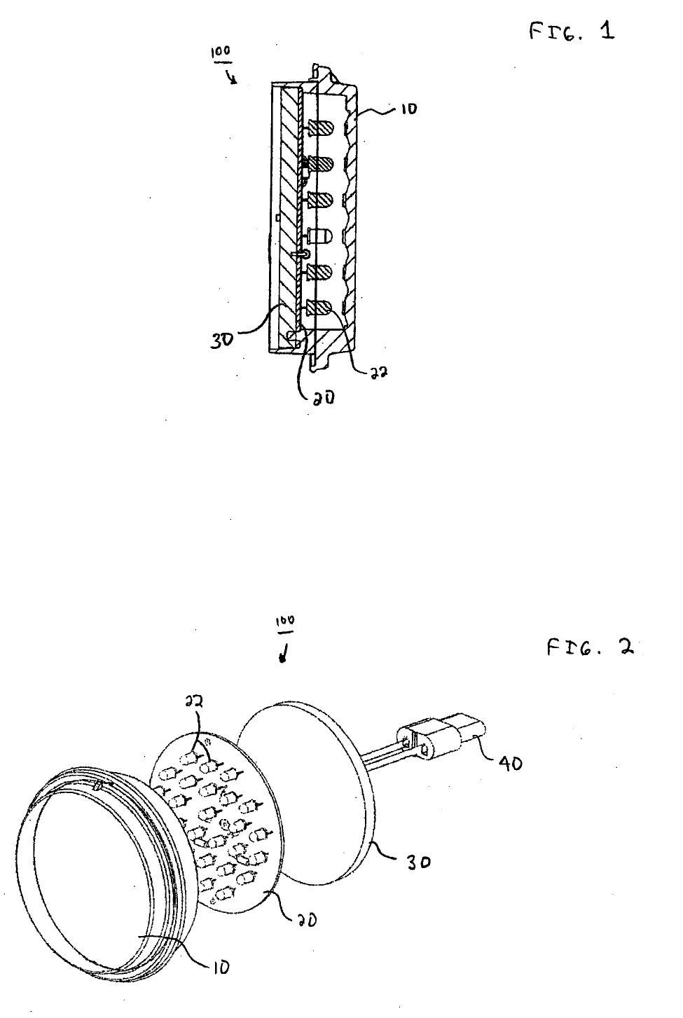

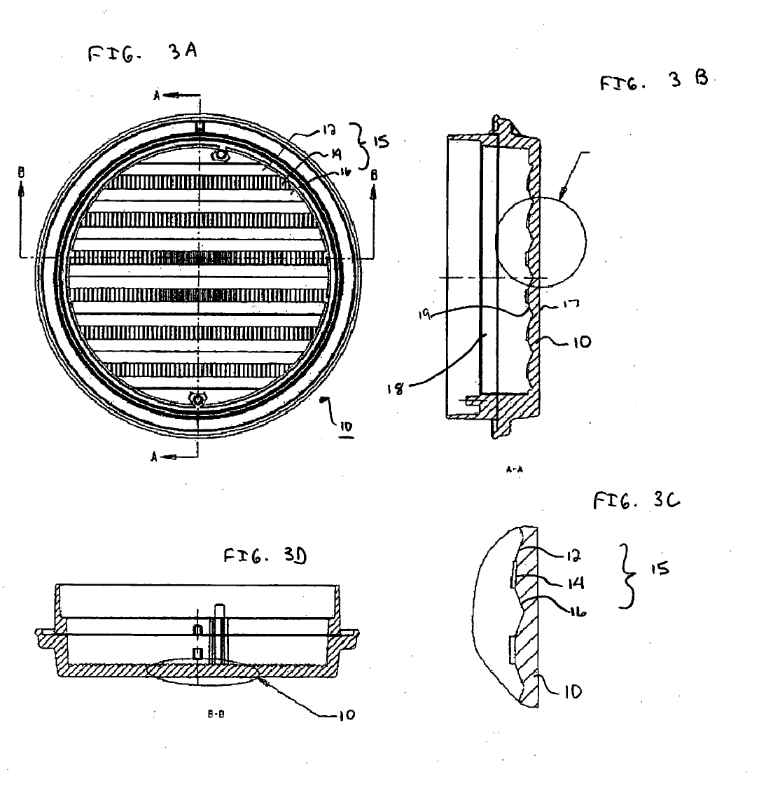

Referring now to the drawings, wherein like reference numerals designate identical or corresponding parts throughout the several views, and more particularly to each of FIGS. 1 and 2 thereof, the LED light 100 of the present invention is shown. FIG. 1 shows the LED light 100 in a completed final form, and FIG. 2 shows the LED light 100 in an exploded view. The LED light 100 may be particularly suited as a vehicle backup light that provides a visual indication when a vehicle is placed in reverse.

As shown in FIGS. 1 and 2 the LED light 100 includes an LED board 20 on which a plurality of LEDs 22 are mounted. In a preferred embodiment the LEDs 22 will be mounted in rows. The number of LEDs 22 and the number of rows of LEDs can vary, particularly as LED technology improves and more light output is generated per LED. Details of the driving circuitry for the LEDs 22 is not shown in the figures and any conventional driving circuitry can be utilized in the LED light 100.

The LED board 20 is provided between a back housing 50 and a lens 10. The lens 10 attaches to the back housing 50. Further, formed between the LED board 20 and the back housing 50 is an area filled by a potting compound 30. The potting compound 30 can fill an entire area behind the back of the LED board 20 (i.e. between the LED board 20 and the back housing 50), and thereby completely seal the LED light 100. The potting compound 30 can be formed of a two component resin system of a silicon based material including resin and hardener material.

The potting compound 30 serves several functions in the LED light 100. First, the potting compound 30 can operate as a weatherproof sealant by sealing the LED light 100. Further, LEDs generate a significant amount of heat, and the potting compound 30 can operate as a heat sink for cooling the driving circuitry for the LEDs 22.

Also shown in FIG. 2 is a connector 40 for providing electrical connection into the appropriate socket in the vehicle, in a standard way.

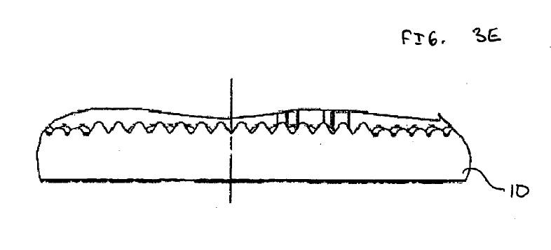

FIGS. 3A-3E show details of the lens 10 of FIGS. 1 and 2. The lens 10 can be structured to provide a viewing angle of 20 degrees with the below discussed structure. The lens 10 serves both optical and mechanical purposes. As shown for example in FIG. 3B the lens has an exterior surface 17 and an interior surface 19. The exterior face 17 faces externally of the LED light 100 and the interior surface 19 faces the LEDs 22. The exterior surface 17 is a substantially smooth surface, as shown for example in FIG. 3B. By making the exterior surface 17 smooth, that exterior surface 17 can avoid collecting dust, which in turn avoids reduction of light output intensity.

As shown in FIGS. 3A and 3C the lens 10 also includes a plurality of rows 15 of horizontal bands. The rows of horizontal bands 15 can be structured so that one row of horizontal bands 15 is aligned with one respective row of LEDs 22. A detail of each band 15 is shown in FIGS. 3A and 3C. As shown in FIGS. 3A and 3C each horizontal band 15 includes an upper region 12, a middle region 14, and a lower region 16. The middle region 14 includes a number of grooves that can be placed vertically or on a plane with an angle to the vertical plane.

As shown in FIG. 3B the lens 10 also includes a shelf 18 that can hold the LED board 22. The use of the shelf 18 can ensure that the LED board 22, and thereby the LEDs 22 mounted thereon, are always kept at a proper distance from the lens 10, so that the lens 10 can provide the proper optical properties for light output from the LEDs 22. The lens 10 can also include mounting posts (not shown) to orient the LED board 22 in a correct direction, and to orient the rows of LEDs 22 with each respective horizontal band 15.

The LED light 100 can be made such that after the LED board 22 is in place on the shelf 18, the potting compound 30 in liquid form can fill in the back of the LED board 22, to provide a seal for the LED light 100 after the potting compound cures.

FIG. 3D shows a cross-section view along B-B in FIG. 3A, and thereby FIG. 3D shows different optical details than along the cross-section A-A shown in FIGS. 3B and 3C. FIG. 3E provides a detailed view of the encircled portion in FIG. 3D.

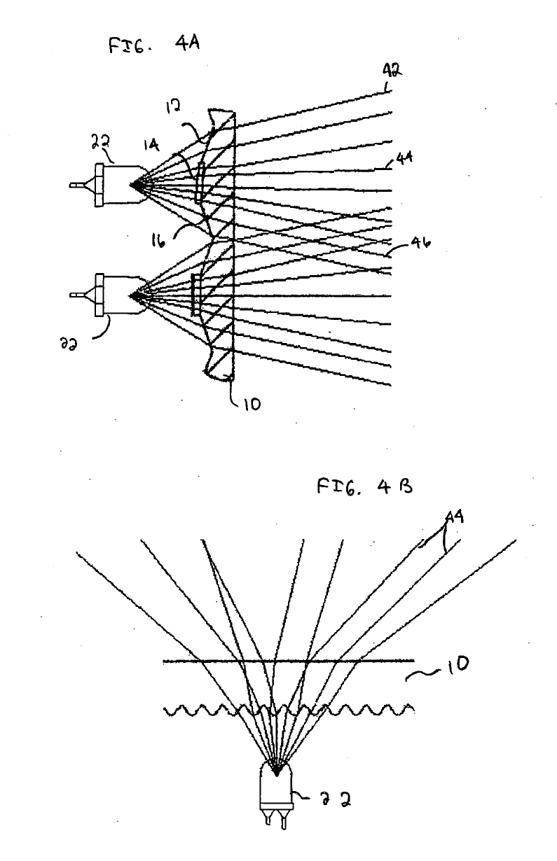

FIGS. 4A and 4B provide a detailed explanation of how the horizontal bands 15 of the lens 10 provide effective optical properties to enhance the operation and viewability of the LED light 100 of the present invention.

As shown in FIG. 4A the lens 10 receives light output from LEDs 22. FIG. 4A shows two LEDs 22 that would be in different rows, and thus FIG. 4A shows how light output from the LEDs is optically processed in a vertical direction. FIG. 4B shows how light output from one LED 22 is optically processed in a horizontal direction, i.e., in the direction in which each individual horizontal band 15 extends in the orientation shown in FIG. 3A.

As shown in FIG. 4A light rays 42 output from the LEDs 22 impinging on the upper region 12 of the band 15 are refracted in a downward direction. Light rays 46 output from the LEDs 22 impinging on the lower region 16 of the band 15 are refracted in an upward direction. Light rays 44 passing through the middle region 14, i.e. the grooves, of the bands 15 will bend vertically depending on the groove position to the vertical plane. If the grooves are parallel to the vertical plane, the light will be bent horizontally only; but if the grooves are formed with an angle to the vertical plane, the light will be bent both horizontally and vertically. However, the light rays 44 passing through the middle region 14, i.e. passing through the grooves in the middle region 14, will be diverged in the horizontal direction as shown in FIG. 4B.

As a result of the optical processing provided by the lens 10 as shown in FIGS. 4A and 4B, light output from the LEDs 22 diverges in a horizontal direction but converges in a vertical direction after passing through the lens 10. Such an optical processing provides enhanced viewability of light output by the LEDs 22.

With the structure of the LED light 100 of the present invention several benefits are achieved. First, the LED light 100 provides a high efficiency and long lasting light source by utilizing LEDs 22. Further, the LED light 100 utilizes an effective sealing and heat sinking property by use of the potting compound 30. Further, the LED light 100 has a lens 10 structure that avoids collecting dust and thereby avoids reducing signal intensity caused by collected dust, and that can direct light output from the LEDs in a way to enhance viewability.

Obviously, numerous modifications and variations of the present invention are possible in light of the above teachings. It is therefore to be understood that within the scope of the appended claims, the present invention may be practiced otherwise than as specifically described herein.

1. A vehicle light comprising:
(a) a light emitting diode (LED) board having first and second sides, and on which at least one LED is mounted on said first side;
(b) a lens positioned at a distance from said LED board and to face said first side of said LED board; and
(c) a potting compound provided on said second side of said LED board.

2. A vehicle light according to claim 1, wherein said vehicle light is a vehicle backup light.

3. A vehicle light according to claim 1, wherein said potting compound completely fills said second face of said LED board.

4. A vehicle light according to claim 1, wherein said lens includes a first surface facing an external side of said LED light that is substantially smooth and a second surface facing said LED board.

5. A vehicle light according to claim 4, wherein said second surface of said lens is contoured to include an upper region to refract light in first direction, a lower region to refract light in a second direction opposite to the first direction, and a middle region.

6. A vehicle light according to claim 5, wherein said middle region diverges light in a horizontal direction and converges light in a vertical direction.

7. A vehicle light according to claim 1, wherein said potting compound includes a silicone based resin and a hardener material.

8. A vehicle light according to claim 1, wherein said lens comprises a shelf configured to maintain said LED board a predetermined distance from said lens.

9. A LED vehicle light according to claim 1, wherein said LED board comprises a plurality of rows of LEDs, and said lens includes a plurality of rows of horizontal bands with one of the rows of horizontal bands aligning with one respective row of LEDs.

10. A vehicle light comprising:
(a) support means, having first and second sides, for supporting at least one LED mounted on first said side;
(b) optical means positioned at a distance from said support means for facing said first side of said support means; and
(c) heat sink and sealing means provided on said second side of said support means.

11. A vehicle light according to claim 10, wherein said vehicle light is a vehicle backup light.

12. A vehicle light according to claim 10, wherein said heat sink and sealing means completely fills said second face of said support means.

13. A vehicle light according to claim 10, wherein said optical means includes a first surface facing an external side of said LED light that is substantially smooth and a second surface facing said support means.

14. A vehicle light according to claim 13, wherein said second surface of said optical means is contoured to include an upper region to refract light in first direction, a lower region to refract light in a second direction opposite to the first direction, and a middle region.

15. A vehicle light according to claim 14, wherein said middle region diverges light in a horizontal direction and converges light in a vertical direction.

16. A vehicle light according to claim 10, wherein said heat sink and sealing means includes a silicone based resin and a hardener material.

17. A vehicle light according to claim 10, wherein said optical means comprises a shelf configured to maintain said support means a predetermined distance from said optical means.

18. A LED vehicle light according to claim 10, wherein said support means comprises a plurality of rows of LEDs, and said optical means includes a plurality of rows of horizontal bands with one of the rows of horizontal bands aligning with one respective row of LEDs.
